(19) United States
(12) Patent Application Publication
(10) Pub. No.: US 2014/0143427 A1
(43) Pub. Date: May 22, 2014

(54) Providing Resources in a Cloud

(71) Applicants: Uwe Hohenstein, Vaterstetten (DE); Michael Jäger, Munchen (DE); Anna-Sophie Schwanengel, Munchen (DE)

(72) Inventors: Uwe Hohenstein, Vaterstetten (DE); Michael Jäger, Munchen (DE); Anna-Sophie Schwanengel, Munchen (DE)

(21) Appl. No.: 14/086,795

(22) Filed: Nov. 21, 2013

(30) Foreign Application Priority Data
Nov. 22, 2012 (DE) DE 102012221355.4

(51) Int. Cl. H04L 29/08

(52) U.S. Cl. CPC H04L 67/16
USPC 709/226

(57) ABSTRACT

A method for providing resources in a cloud includes interrogating current location-based data relating to potential users of the cloud, and calculating a future resource requirement in local computing centers of the cloud based at least on the current location-based data relating to the potential users. The method also includes automatically providing resources in the local computing centers of the cloud according to the calculated future resource requirement of the local computing centers.

This application claims the benefit of DE 10 2012 221 355.4, filed on Nov. 22, 2012, which is hereby incorporated by reference in its entirety.

### TECHNICAL FIELD

The present embodiments relate to providing resources in a cloud.

### BACKGROUND

Modern computer applications are being operated more and more frequently in a cloud. Reference is also made to cloud computing in this context.

Cloud computing may be an abstracted IT infrastructure in which the resources (e.g., computing capacity, data memory, network capacities) may be dynamically adapted to the resource requirement. This abstracted IT infrastructure may be accessed via a network. This abstracted IT infrastructure appears to the user as a remote server, for example, that may not be specifically defined by the user, like being shrouded in a “cloud.”

In this case, an application is operated in a cloud using defined technical interfaces and protocols.

In the case of a cloud, the hardware is therefore not operated or provided by the user of an application himself. Rather, abstracted hardware is hired from one or more cloud providers as a service that may also be geographically remote, for example. The user's applications and data are then no longer on the local computer but rather in the cloud.

The cloud may be accessed via a network (e.g., the Internet). However, a cloud may also be operated by a company, for example, as a private cloud in which the abstracted IT infrastructure is provided via a network (e.g., an intranet) belonging to the company.

In a cloud, the number of resources (e.g., memories or computing power) appears to be approximately unlimited since these resources may be requested or additionally requested in a virtually arbitrary manner at any time as required. Cloud providers provide corresponding payment models in which only the requested resources often are to be paid for, and no initial investments in hardware or resources are to be made.

The resources required by a cloud application may be ordered or requested in this case from the cloud operator by the application operator in order to react to changed load situations.

For this purpose, modern cloud computing platforms may make it possible to adjust the quantity of required resources on a corresponding portal (e.g., an Internet portal in the form of a website) via a resource adjustment interface. In this case, the operation of requesting the resources is a manual activity and is the responsibility of the operator of the respective cloud application.

For example, user requests may be processed in a private IT infrastructure, and a connected external cloud computing platform may be used in the event of overload situations in the home IT infrastructure, on which platform additional virtual machines may be provided. The additional virtual machines are requested manually in this case, as already described above.

Modern systems make it possible to monitor the performance of an application that is executed in a cloud. Different characteristic numbers, for example, may be used in this case. One possible characteristic number may provide information on whether problems will occur in the near future, and a further characteristic number may infer an already existing overload. For example, the first characteristic number may be the quantity of requests in a queue, long processing times of requests, maximum CPU utilization and few processing operations per second or the like. In this case, the second characteristic number may be the number of applications or processes to be restarted.

The document Alam, K., Keresteci, E., Nene, B., and Swanson, T. (2011), Documentation, http://cloudninja.codeplex.com/releases/view/65798, for example, shows such a method in which the evaluation of the current performance data and the corresponding resource management are carried out manually.

The manual provision of the resources based on reservations results in required resources being provided too late and in a user, for example, already having been impaired. For this reason, more resources than the currently required resources may be reserved for an application operated in a cloud. A generously dimensioned reservation makes it possible to intercept load peaks, but this also results in an increased energy requirement in the cloud. This also increases the price for operating the cloud and for operating an application in a cloud.

Cloud operators may operate a plurality of computing centers distributed across the globe. In this case, the customer of the cloud operator may select in which of the computing centers his application is intended to be operated.

Therefore, the aspect of the geographical vicinity of the potential users of an application in a cloud to the computing center belonging to the cloud operator, in which the respective application is operated, may also be taken into account when providing resources.

There are different possibilities for accounting for geographical vicinity. For example, resources may be provided in different computing centers belonging to the cloud operator according to a predefined pattern on the basis of the time of day. Conurbations may be determined, for example, according to the population, and resources may be increasingly provided there.

In this case, this distribution of the resources is statically configured and may be configured manually by the customer of the cloud operator.

### SUMMARY AND DESCRIPTION

The scope of the present invention is defined solely by the appended claims and is not affected to any degree by the statements within this summary.

The present embodiments may obviate one or more of the drawbacks or limitations in the related art. For example, a possible way of efficiently providing resources in a cloud is provided.

In one embodiment, a method for providing resources in a cloud includes interrogating current location-based data relating to potential users of the cloud, and calculating a future resource requirement in local computing centers of the cloud at least based on the location-based data relating to the potential users. The method also includes automatically providing resources in the local computing centers of the cloud according to the calculated future resource requirement of the local computing centers.

In one embodiment, an apparatus for providing resources in a cloud includes an interrogating device configured to interrogate current location-based data relating to potential users of the cloud, and a computing device configured to calculate a future resource requirement in local computing centers of the cloud at least based on the location-based data relating to the potential users. The apparatus includes a provision device configured to automatically provide resources in the local computing centers of the cloud according to the calculated future resource requirement of the local computing centers.

A resource requirement of a cloud is divided into a respective resource requirement in different computing centers belonging to the cloud operator.

This knowledge may be taken into account, and a possible way of automatically adapting the resources provided in a cloud to likely load scenarios is provided. In this case, according to one or more of the present embodiments, location-based data relating to potential users of the cloud are used to predict the future resource requirement of the cloud.

Since the data relating to the potential users of the cloud are acquired in a location-based manner, a statement may be made not only on the quantity of resources required but also on the location at which the resources are required.

Cloud providers may have a plurality of computing centers that may be distributed across the entire globe. In the United States of America, for example, cloud providers may maintain a plurality of computing centers. Therefore, at any location at which cloud resources are required, the location-based data may be used to identify the corresponding computing center belonging to the cloud provider that may best supply the respective location with data. The resources may then be provided in the local computing center identified.

One or more of the present embodiments are therefore based on assigning residence data that is provided by Internet users, for example, to a locality or an area and correlating a generally high number of users with a high load on one's own service or application that is operated in the cloud.

One or more of the present embodiments make it possible to optimally distribute the cloud resources. This makes it possible to reduce the reaction times or response times when accessing the cloud. The data traffic in the data network belonging to the cloud provider is reduced since the data may be delivered from the nearest local computing center belonging to the cloud provider.

One or more of the present embodiments therefore make it possible to deliberately react to a local increased load. Such an increased load may occur, for example, during a Champions League game in Munich or the Super Bowl in an American city.

In one embodiment, the current location-based data for predefined reference locations are interrogated when interrogating current location-based data relating to the potential users of the cloud. If representative reference locations are selected, the volume of data that is to be evaluated in order to be able to make a statement on a local load development for the cloud may be reduced with approximately the same prediction quality.

In one embodiment, the reference locations are assigned to the local computing center of the cloud that geographically is at the shortest distance from the respective reference locations. This makes it possible to easily assign the reference locations to the respective computing centers.

In one embodiment, the reference locations are assigned to the local computing center of the cloud that has the fastest data connection to the respective reference locations. This provides that a reference location is assigned to that computing center from which the location may best be supplied with data. This may not always be the geographically closest computing center.

In one embodiment, the current location-based data is interrogated from a search engine, a message service, a geocaching service, a geotagging service, a social network, an electronic agenda of at least one of the potential users of the cloud, or a combination thereof. Providing different sources for the location-based data makes it possible to adapt one or more of the present embodiments to different boundary conditions. If a geocaching service or a geotagging service is used, very detailed location-based data may be acquired, for example. Such a geocaching service or geotagging service may be, for example, Foursquare.com, Gowalla.com, Google Latitude or the like. Social networks (e.g., Facebook, Twitter or Google+) may also provide location-based information.

In one embodiment, the current location-based data is interrogated and/or aggregated at predefined intervals of time. If location-based data is interrogated at intervals of time, the computing complexity is reduced considerably in comparison with continuous acquisition, for example.

In one embodiment, a trend for the future resource requirement is extrapolated from the location-based data interrogated and/or aggregated at predefined intervals of time when calculating the future resource requirement. This makes it possible to make a statement on the future development of the resource requirement in the cloud, even for relatively long periods.

In one embodiment, at least one resource guarantee, a provisioning time for the respective resources, resource costs of the respective resources, or a combination thereof is taken into account when calculating the future resource requirement. This makes it possible to control the provision of the resources for the cloud not only on the basis of resource requirement characteristic numbers. Rather, fuzzy specifications may also be included in the calculations. The fuzzy specifications make it possible to also bear in mind further aims in addition to the quality assurance of the cloud.

In one embodiment, the automatic provision of resources in the cloud includes the provision of computing power, main memory, transmission bandwidth, or a combination thereof. This makes it possible to individually adapt the provision of the resources to the load situation to be expected.

In one embodiment, resources are automatically provided via an application interface of the cloud. The use of a standardized API makes it possible to automatically provide the resources in a very simple manner.

The above refinements and developments may be combined with one another in any desired manner if useful. Further possible refinements, developments and implementations of the invention also include combinations of features of the invention not previously described or described below with respect to the exemplary embodiments. For example, a person skilled in the art will also add individual aspects to the respective basic form of the present invention as improvements or additions.

### BRIEF DESCRIPTION OF THE DRAWINGS

FIG. 1 shows a flowchart of one embodiment of a method;

FIG. 2 shows a block diagram of one embodiment of an apparatus;

FIG. 3 shows an illustration of a cloud infrastructure having one embodiment of an apparatus; and

FIG. 4 shows a block diagram of a further embodiment of an apparatus.

### DETAILED DESCRIPTION

In all figures, same or functionally same elements and apparatuses have been provided with the same reference symbols unless stated otherwise.

The term “local computing center” may be one of the computing centers in which the cloud provider operates the computers that form the basis for the cloud. In this case, local computing centers may be geographically separate from one another. For example, computing centers may be arranged in each federal state in order to enable an extensive supply.

The term “potential users” may be persons who may access the cloud or an application operated in the cloud. The potential users may be, for example, persons who register with a social network or a geocaching or geotagging service using a computer or smartphone. However, the potential users may also be persons who participate in a major event (e.g., a Champions League game in Munich).

The term “reference location” relates to selected locations that enable representative determination of the location-based data for potential users of the cloud without a large geographical area having to be analyzed in detail. For example, the reference locations of Powell St., Embarcadero and Moscone Center may be selected for a local computing center in San Francisco.

The practice of providing resources may be the practice of providing a suitable quantity of resources. This provides that the practice of providing resources may also be the practice of reducing existing resources. If the calculation of the future resource requirement reveals, for example, that fewer resources than currently available will be required in the future, the existing resources are accordingly reduced to the calculated future resource requirement by the automatic provision of resources.

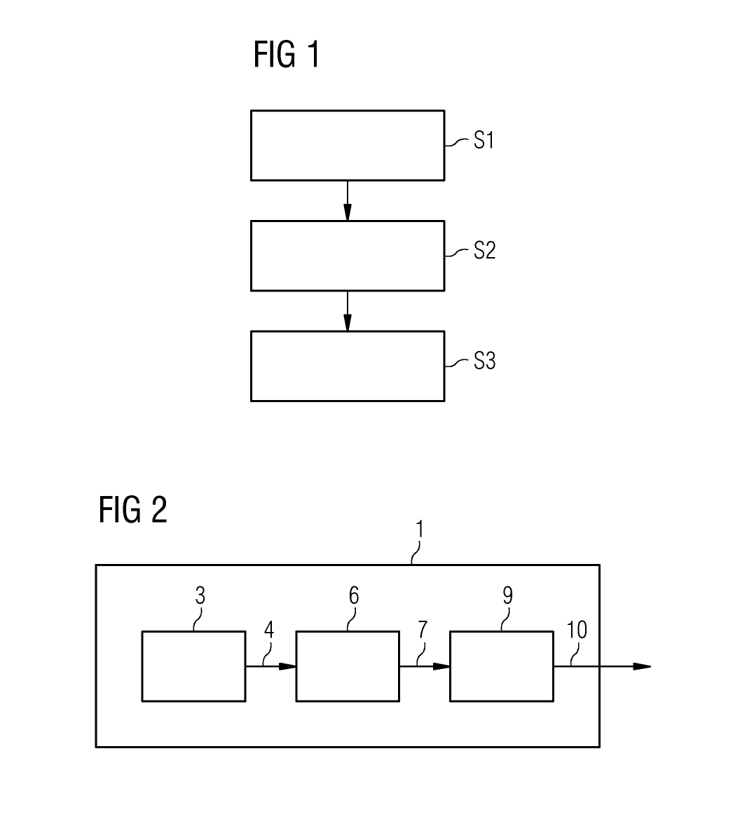

FIG. 1 shows a flowchart of one embodiment of a method for providing resources in a cloud.

In act S1, the method provides for an interrogation S1 of current location-based data 4 relating to potential users 5 of the cloud 2.

In act S2, a future resource requirement 7 in local computing centers 8 of the cloud 2 is calculated based on at least the location-based data 4 relating to the potential users 5.

In act S3, resources 10 are automatically provided in the local computing centers 8 of the cloud 2 according to the calculated future resource requirement 7 of the local computing centers 8.

In this case, the location-based user data 4 may be interrogated in different ways. The location-based user data 4 may be interrogated, for example, using a social network that provides information relating to the current location of the respective potential users 5. Special geocaching services 15 or geotagging services 15 or the like may be used to interrogate the location-based user data 4.

In one embodiment, the current location-based data 4 for predefined reference locations 11 are interrogated when interrogating current location-based data 4 relating to the potential users 5 of the cloud 2.

In one embodiment, the reference locations 11 are also assigned to that local computing center of the cloud 2 that has the fastest data connection to the respective reference locations 11. In this case, “the fastest data connection” provides that the computing center has either the data connection with the widest bandwidth, the shortest latency or the like with respect to the reference locations 11.

In one embodiment, the current location-based data 4 are interrogated or aggregated at predefined intervals of time. For example, the current location-based data 4 may be stored in a table similar to Table 1.

TABLE 1

| California | 07:00 | 07:30 | 08:00 | 08:30 | 09:30 | 10:00 |
|---|---|---|---|---|---|---|
| Powell St. | 43 | 235 | 121 | 43 | 4 | 445 |
| Embarcadero | 45 | 435 | 143 | 54 | 6 | 344 |
| Moscon Center | 56 | 562 | 186 | 43 | 7 | 742 |
| Union Square | 33 | 333 | 134 | 35 | 3 | 532 |
| Berkeley St. | 54 | 87 | 234 | 32 | 5 | 344 |

The times in table 1 are only exemplary. In other embodiments, other periods of time and other intervals of time may be considered.

Further data may be managed in tabular form, for example. The set of local computing centers 8 may therefore be stored together with the reference locations 11 assigned to the respective computing center.

In one embodiment, a trend 13 for the future resource requirement 7 is extrapolated from the location-based data 4 interrogated and/or aggregated at predefined intervals of time when calculating the future resource requirement 7.

In one embodiment, at least one resource guarantee and/or a provisioning time for the respective resources 10 and/or resource costs of the respective resources 10 are taken into account when calculating the future resource requirement 7.

In one embodiment, the automatic provision of resources 10 in the cloud 2 includes the provision of computing power and/or main memory and/or transmission bandwidth.

In one embodiment, resources 10 are automatically provided via an application interface 14 of the cloud 2. This may be a suitable API, for example.

FIG. 2 shows a block diagram of one embodiment of an apparatus 1.

The apparatus 1 has an interrogating computer or device 3 configured to interrogate current location-based data 4 relating to potential users 5 of the cloud 2 and to provide a computing computer or device 6 with the location-based data 4.

The computing computer or device 6 calculates a future resource requirement 7 in local computing centers 8 of the cloud 2 at least based on the location-based data 4 relating to the potential users 5 and transmits the future resource requirement 7 to a provision computer or device 9.

The provision computer or device 9 is configured to automatically provide resources 10 in the local computing centers 8 of the cloud 2 according to the calculated future resource requirement 7 of the local computing centers 8.

In this case, the provision device 9 uses an API 14 of the cloud 2, for example, to access the settings of the cloud 2 and uses the API 14 of the cloud 2 to request the resources 10 according to the future resource requirement 7 for the individual local computing centers 8.

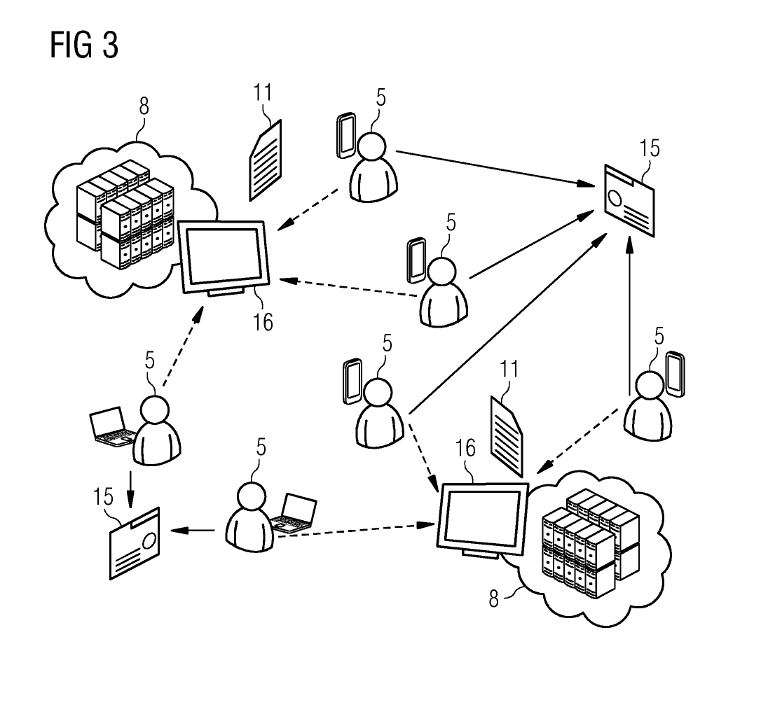

FIG. 3 shows an illustration of a cloud infrastructure having one embodiment of an apparatus 1.

The cloud 2 in FIG. 3 has two local computing centers 8. In other embodiments, the cloud 2 may have a different number of local computing centers 8. The application 16 operated in the cloud 2 is respectively executed in the local computing centers 8 of the cloud 2. Lists containing the corresponding reference locations 11 are also stored for the individual local computing centers 8.

FIG. 3 also illustrates two geotagging or geocaching services 15.

A plurality of potential users 5, each illustrated in FIG. 3 together with a mobile computer or smartphone, inform the geotagging or geocaching services 15 of their respective position. The position is interrogated and processed by an interrogating device 3, for example.

The apparatus 1 according to one or more of the present embodiments is not illustrated in FIG. 3 for the sake of clarity. Rather, FIG. 3 is used to illustrate the infrastructure in which the apparatus 1 may be used.

In one exemplary embodiment, a provider of an application 15 provides a walkie-talkie function for smartphones in the form of a smartphone app. Users may therefore talk to one another for free.

In order to be able to transmit voice via the data connection in normal Internet traffic (and not via the GSM or UMTS voice coding), the system accordingly codes the spoken message.

Technically, the system may be based on a peer-to-peer approach, for example, which (e.g., in a similar manner to Skype) implements distributed routing via distributed switching nodes. The network and the infrastructure are therefore scale-free (e.g., further switching nodes are used with an increasing number of users in order to provide a constant service quality). The number of users may therefore increase in an arbitrary manner from a technical point of view.

In one embodiment, the aim of the provider may be to provide a short delay of the provided service as a result of the distributed infrastructure. Delay-free operation is therefore of the highest priority for the provider.

In order to achieve this aim, the provider may estimate the load in advance in order to avoid having to react only to the load that has already occurred (e.g., in order to avoid also connecting new entities to the cloud 2 only when many customers actually use the service at the same time, and the load volume increases as a result of the entirety of the customers).

The technical strategy of the provider may be that of setting up the server software entities of the switching nodes in the relative proximity of the clients. This makes it possible to better cover conurbations. With new cloud computing offers for virtual servers (SaaS), different computing centers in which server entities of the service are started or stopped in order to provide proximity to the customers are therefore identified.

The provider may use different servers in every federal state, for example. This has the organizational advantage that an Internet provider is always available in the conurbation of a federal state.

Since virtual servers for cloud computing are invoiced via a provisioning model, the aim of the provider is to dimension the capacity of the provisioned computers as accurately as possible to the actually required capacity.

The provider may use the mobile radio provider's own sales figures and market data to determine the size of the user base of the mobile radio provider and the entire user base, for example. This data is regularly updated based on the availability of the data from the mobile radio provider and the tracking of the provider's own sales.

The provider uses the geotagging service to determine the number of users at representative locations within Germany. During normal operation, it may be assumed that the number of users of the walkie-talkie service behaves in a similar manner to the number of smartphone users and may be adapted with the market change (sales figures).

If, however, events that require adaptation of the cloud resources in a federal state (e.g., as a result of an event recognized throughout the world, such as the Champions League final in Munich or a Madonna tour through Germany's cities with a million inhabitants) now occur, the proposed method makes it possible to accordingly react thereto by interrogating the geotagging services.

The cloud resources are accordingly adapted, and more or less capacity is planned and provided, depending on the event, in order to provide a constant good and professional service quality.

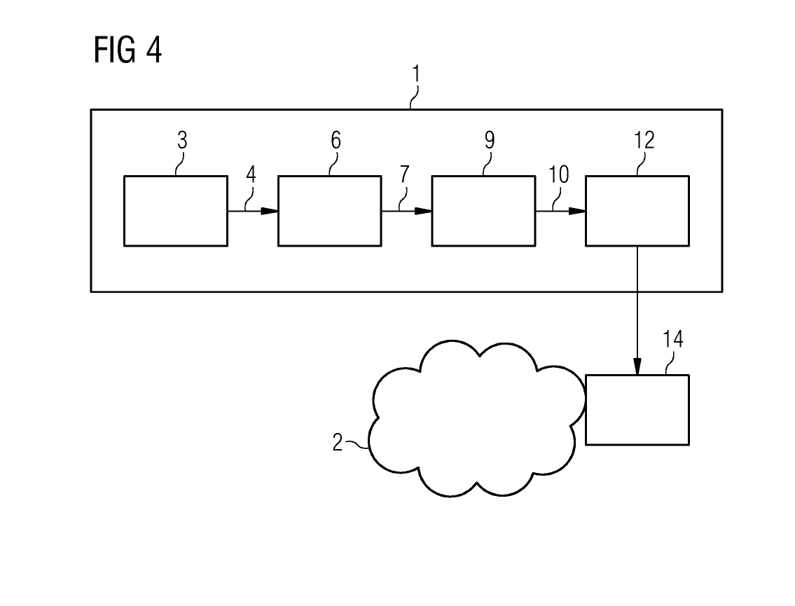

FIG. 4 shows a block diagram of a further embodiment of an apparatus 1.

The apparatus 1 in FIG. 4 differs from the apparatus in FIG. 1 in that the apparatus 1 in FIG. 4 has a communication device 12 that receives an item of information relating to the required resources 10 from the provision device 9. The communication device 12 is also coupled to an application interface 14 of the cloud 2 (e.g., a REST-API 14) in order to request the resources 10 in the cloud 2.

In this case, the communication interface 12 may be a network interface that is suitable for communicating via the Internet. For example, the communication interface 12 may be in the form of an Ethernet interface, WLAN interface or the like.

Although the present invention is described above using exemplary embodiments, the present invention is not restricted thereto, but rather may be modified in various ways. For example, the invention may be changed or modified in diverse ways without departing from the essence of the invention.

It is to be understood that the elements and features recited in the appended claims may be combined in different ways to produce new claims that likewise fall within the scope of the present invention. Thus, whereas the dependent claims appended below depend from only a single independent or dependent claim, it is to be understood that these dependent claims can, alternatively, be made to depend in the alternative from any preceding or following claim, whether independent or dependent, and that such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A method for providing resources in a cloud, the method comprising:
interrogating current location-based data relating to potential users of the cloud;
calculating a future resource requirement in local computing centers of the cloud at least based on the current location-based data relating to the potential users; and
automatically providing resources in the local computing centers of the cloud according to the calculated future resource requirement of the local computing centers.

2. The method of claim 1, further comprising interrogating the current location-based data for predefined reference locations when the current location-based data relating to the potential users of the cloud is interrogated.

3. The method of claim 2, wherein the reference locations are assigned to a local computing center of the cloud that has a fastest data connection to the respective reference locations.

4. The method of claim 1, wherein the interrogating comprises interrogating the current location-based data from a search engine, a message service, a geocaching service, a geotagging service, a social network, an electronic agenda of at least one of the potential users of the cloud, or a combination thereof.

5. The method of claim 1, wherein the current location-based data is interrogated, aggregated, or interrogated and aggregated at predefined intervals of time.

6. The method of claim 5, wherein a trend for the future resource requirement is extrapolated from the location-based data interrogated, aggregated, or interrogated and aggregated at predefined intervals of time when the future resource requirement is calculated.

7. The method of claim 1, wherein the calculating comprises taking at least one resource guarantee, a provisioning time for the respective resources, resource costs of the respective resources, or a combination thereof into account.

8. The method of claim 1, wherein the automatically providing of resources in the local computing centers of the cloud comprises providing computing power, main memory, transmission bandwidth, or a combination thereof.

9. The method of claim 1, wherein the automatically providing of resources in the local computing centers of the cloud comprises automatically providing the resources via an application interface of the cloud.

10. The method of claim 3, wherein the interrogating comprises interrogating the current location-based data from a search engine, a message service, a geocaching service, a geotagging service, a social network, an electronic agenda of at least one of the potential users of the cloud, or a combination thereof.

11. An apparatus for providing resources in a cloud, the apparatus comprising:
an interrogating computer configured to interrogate current location-based data relating to potential users of the cloud;
a computing computer configured to calculate a future resource requirement in local computing centers of the cloud at least based on the current location-based data relating to the potential users; and
a provision computer configured to automatically provide resources in the local computing centers of the cloud according to the calculated future resource requirement of the local computing centers.

12. The apparatus of claim 11, wherein the interrogating computer is further configured to interrogate the current location-based data for predefined reference locations when the current location-based data relating to the potential users of the cloud is interrogated, and
wherein the reference locations are assigned to a local computing center of the local computing centers of the cloud that has a fastest data connection to the respective reference locations.

13. The apparatus of claim 11, wherein the interrogating computer comprises a communication device configured to interrogate the current location-based data from a search engine, a message service, a geocaching service, a geotagging service, a social network, an electronic agenda of at least one of the potential users of the cloud, or a combination thereof.

14. The apparatus of claim 13, wherein the communication device is further configured to interrogate, aggregate, or interrogate and aggregate the current location-based data at predefined intervals of time, and
wherein the computing computer is further configured to extrapolate a trend for the future resource requirement from the location-based data interrogated, aggregated, or interrogated and aggregated at predefined intervals of time when the future resource requirement is calculated.

15. The apparatus of claim 11, wherein the computing computer is further configured to take into account at least one resource guarantee, a provisioning time for the respective resources, resource costs of the respective resources, or a combination thereof when the future resource requirement is calculated.

16. The apparatus of claim 11, wherein the provision computer is further configured to provide computing power, main memory, transmission bandwidth, or a combination thereof when the resources in the cloud are automatically provided, and
wherein the provision computer is further configured to automatically provide the resources via an application interface of the cloud.

17. The apparatus of claim 12, wherein the interrogating computer comprises a communication device configured to interrogate the current location-based data from a search engine, a message service, a geocaching service, a geotagging service, a social network, an electronic agenda of at least one of the potential users of the cloud, or a combination thereof.

18. The apparatus of claim 17, wherein the communication device is further configured to interrogate, aggregate, or interrogate and aggregate the current location-based data at predefined intervals of time, and
wherein the computing computer is further configured to extrapolate a trend for the future resource requirement from the location-based data interrogated, aggregated, or interrogated and aggregated at predefined intervals of time when the future resource requirement is calculated.

19. The apparatus of claim 12, wherein the computing computer is further configured to take into account at least one resource guarantee, a provisioning time for the respective resources, resource costs of the respective resources, or a combination thereof when the future resource requirement is calculated.

20. The apparatus of claim 12, wherein the provision computer is further configured to provide computing power, main memory, transmission bandwidth, or a combination thereof when the resources in the cloud are automatically provided, and
wherein the provision computer is further configured to automatically provide the resources via an application interface of the cloud.
